(19) United States
(12) Patent Application Publication
(10) Pub. No.: US 2025/0382828 A1
(43) Pub. Date: Dec. 18, 2025

(54) DOOR LOCKING DEVICE

(71) Applicant: Chad Hauskin, Lafayette, TN (US)

(72) Inventor: Chad Hauskin, Lafayette, TN (US)

(21) Appl. No.: 18/740,974

(22) Filed: Jun. 12, 2024

(51) Int. Cl. E05B 65/00; E05B 15/04; E05B 17/00; E05B 17/20; E05B 47/00

(52) U.S. Cl. CPC E05B 65/0017; E05B 15/04; E05B 17/002; E05B 47/0012; E05B 2015/0413; E05B 17/2084; E05B 2047/0017; E05B 2047/0084

(57) ABSTRACT

A locking device can include a lock housing; a first carriage attached to a first guided member and a second guided member; a locking bolt having a first portion that is slidably retained within the first carriage; a first extension spring connecting an upper portion of the first carriage to an upper portion of the locking bolt; a second extension spring connecting a lower portion of the first carriage to a lower portion of the locking bolt; wherein: the carriage can be actuated to move from at least a first position to a second position within the lock housing, the carriage can be be actuated to move from at least the second position to the first position within the lock housing. The first and second extension springs can be constructed and arranged to absorb any impact applied to the locking bolt.

### TECHNICAL FIELD

The embodiments generally relate to the field of locking devices. In particular, some embodiments generally relate to the field of door locking devices.

### BACKGROUND

Door locking devices can have various issues. For example, when installed for a prison door, the typical door locking device can be susceptible to being damaged by prison inmates, rendering the door locking device inoperative which risks the security of the facility. In some cases, the typical door locking device can be damaged when its locking bolt is struck with a blunt force object. In other cases, the typical door locking device can be damaged by carefully feeding debris around its locking bolt, thereby jamming the locking bolt.

There is a need for a door locking device that is constructed and arranged to withstand impact from blunt force objects, and that prevents jamming of its locking bolt.

### SUMMARY

This summary is provided to introduce a variety of concepts in a simplified form that is further disclosed in the detailed description of the embodiments. This summary is not intended to identify key or essential inventive concepts of the claimed subject matter, nor is it intended for determining the scope of the claimed subject matter.

In general, the disclosed locking device can include a lock housing; a first carriage attached to a first guided member and a second guided member; a locking bolt having a first portion that is slidably retained within the first carriage; a first extension spring connecting an upper portion of the first carriage to an upper portion of the locking bolt; a second extension spring connecting a lower portion of the first carriage to a lower portion of the locking bolt; wherein: the carriage can be actuated to move from at least a first position to a second position within the lock housing, the carriage can be be actuated to move from at least the second position to the first position within the lock housing. In some embodiments, the first and second extension springs can be constructed and arranged to absorb any impact applied to the locking bolt.

Other illustrative variations within the scope of the invention will become apparent from the detailed description provided hereinafter. The detailed description and enumerated variations, while disclosing optional variations, are intended for purposes of illustration only and are not intended to limit the scope of the invention.

### BRIEF DESCRIPTION OF THE DRAWINGS

A more complete understanding of the embodiments, and the attendant advantages and features thereof, will be more readily understood by references to the following detailed description when considered in conjunction with the accompanying drawings wherein:

FIG. 1 illustrates a locking device mounted on a wall, according to some embodiments disclosed herein;

FIG. 2 illustrates a locking device including a locking bolt pushed in by a closing door, according to some embodiments disclosed herein;

FIG. 3 illustrates a locking device being actuated by a closing door, according to some embodiments disclosed herein;

FIG. 4 illustrates a locking device locking a closed door, according to some embodiments disclosed herein;

FIG. 5 illustrates a locking device including a push bolt and a lock cylinder, according to some embodiments disclosed herein;

FIG. 6 illustrates a linkage before being actuated by a lock cylinder of a locking device, according to some embodiments disclosed herein;

FIG. 7 illustrates a lock cylinder actuating a linkage of a locking device, according to some embodiments disclosed herein;

FIG. 8 illustrates a locking device including a blocking arm in a blocking position, according to some embodiments disclosed herein;

FIG. 9 illustrates a locking device including a blocking arm in an unblocking position, according to some embodiments disclosed herein;

FIG. 10 illustrates a locking device including a push bolt pushed in by a closed door, according to some embodiments disclosed herein; and

FIG. 11 illustrates a locking device including a push bolt pushed in by a closed door while a locking bolt is actuated by a lock cylinder, according to some embodiments disclosed herein.

The drawings are not necessarily to scale, and certain features and certain views of the drawings may be shown exaggerated in scale or in schematic in the interest of clarity and conciseness.

### DETAILED DESCRIPTION

The specific details of the single embodiment or variety of embodiments described herein are to the described product or methods of use. Any specific details of the embodiments are used for demonstration purposes only and no unnecessary limitations or inferences are to be understood from there.

It is noted that the embodiments reside primarily in combinations of components and procedures related to the products. Accordingly, the product and components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments described herein can relate to a locking device suitable for locking security doors in prisons, jails, etc. Oftentimes, in prisons and jails, prisoners intentionally damage locking devices to prevent security doors from being locked. In some embodiments, the locking bolt can be constructed and arranged to withstand impact from blunt force objects used by prisoners.

For example, in some embodiments, the locking bolt can be retained within a carriage. One or more extension springs can attach the locking bolt to the carriage, wherein the one or more extension springs are constructed and arranged to absorb impact to the locking bolt. The springs can absorb impact as the impact is transmitted from the locking bolt to the one or more extension springs, and from the one or more extension springs to the carriage. A debris scraper can be constructed and arranged to scrape any debris as the locking bolt is moved from the locked position to the unlocked position.

In some embodiments, the locking device can be made primarily of any durable material such as, for example, metal. In some embodiments, the locking device can be made primarily of steel.

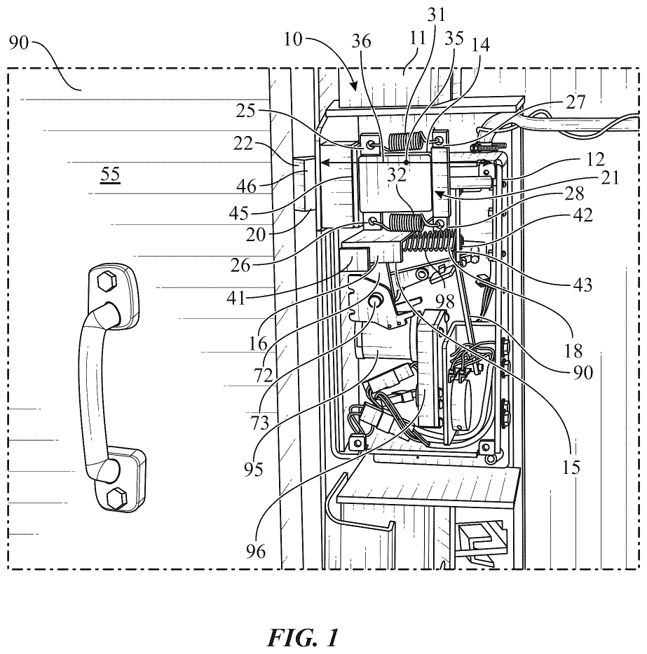

Referring to FIG. 1, a locking device 10 can include a lock housing 12. A first carriage 14 can be attached to a first guided member 16 and a second guided member 18. The first guided member 16 and the second guided member 18 can be any members capable of being guided such as, for example, rods, tracks, wheels, rollers, etc.

A locking bolt 20 can have a first portion 21 that is slidably retained within the first carriage 14. A first extension spring 31 can connect an upper portion 25 of the first carriage 14 to an upper portion 27 of the locking bolt 20. A second extension spring 32 can connect a lower portion 26 of the first carriage 14 to a lower portion 28 of the locking bolt 20. In some embodiments, the first extension spring 31 and the second extension spring 32 can be constructed and arranged to absorb impact to the locking bolt 20.

A first carriage guide 41 can be attached to the lock housing 12 and positioned inside the lock housing 12. The first carriage guide 41 can be constructed and arranged to guide the first guided member 16 attached to the first carriage 14. A second carriage guide 42 can be attached to the lock housing 12 and positioned inside the lock housing 12. The second carriage guide 42 can be constructed and arranged to guide the second guided member 18 attached to the first carriage 14. The first carriage guide 41 and the second carriage guide 42 and be any suitable guides capable of guiding the first guided member 16 and the second guided member 18 such as, for example, tracks, rails, grooves, etc.

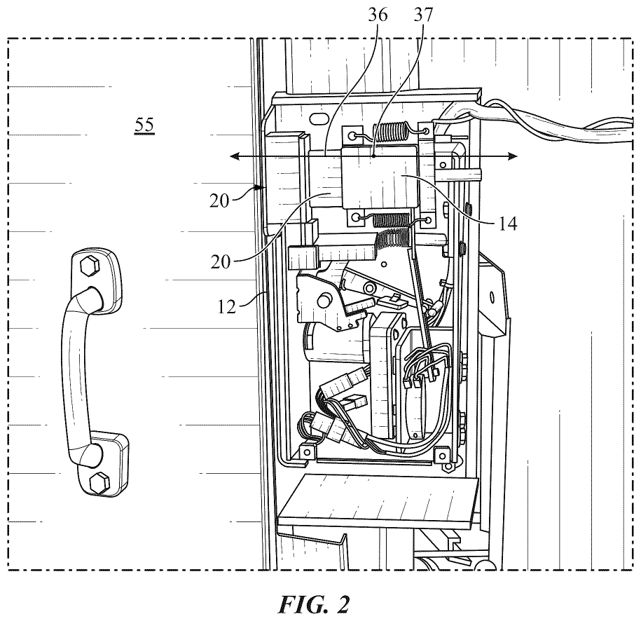

Referring to FIG. 1 and FIG. 2, in some embodiments, the carriage 14 can be further constructed and arranged to be actuated to move from at least a second position 37 in FIG. 2 to the first position 35 in FIG. 1 along an axis 36 in the lock housing 12. The first 35 and second 37 positions can be positions within the lock housing 12. When the carriage 14 is actuated to move to the first position 35 in FIG. 1, the locking bolt 20 is moved to a locked position. For example, when the carriage 14 is actuated to move to the first position 35, at least an end portion 22 of the locking bolt 20 is moved away from the lock housing 12. In some embodiments, when the locking bolt 20 is in the locked position, the end portion 22 of the locking bolt 20 is outside the lock housing 12.

In some embodiments, the carriage 14 can be constructed and arranged to be actuated to move from at least the first position 35 in FIG. 1 to the second position 37 in FIG. 2. When the carriage 14 is actuated to move to the second position 37 in FIG. 2, the locking bolt 20 is moved to an unlocked position. For example, when the carriage 14 is actuated to move to the second position 37, at least the end portion 22 of the locking bolt 20 moves toward the lock housing 12. In some embodiments, when the locking bolt 20 is in the unlocked position, the end portion 22 of the locking bolt 20 is at least partially inside the lock housing 12. In some embodiments, the end portion 22 of the locking bolt 20 can be actuated to be inside the lock housing 12.

A compression spring 98 can be positioned around the second guided member 18. The second carriage guide 42 can have an end stop surface 43. The compression spring 98 can be positioned between the carriage 14 and the end stop surface 43. Referring to FIG. 2, the compression spring 98 can be constructed and arranged to compress when the carriage 14 is moved to the second position 37. Referring to FIG. 1, the compression spring 98 can be constructed and arranged to decompress to return the carriage 14 to the first position 35 so that the locking bolt 20 is returned to the locked position.

In some embodiments, a debris scraper 45 can be mounted to the lock housing 12. In some embodiments, the locking bolt 20 can extend through the debris scraper 45. The debris scraper 45 can be constructed and arranged to scrape debris 46 from the locking bolt 20 as the locking bolt 20 moves from the locked position in FIG. 1 to the unlocked position in FIG. 2. In some embodiments, the debris scraper 45 can be floatingly mounted to the lock housing 12. In some embodiments, the debris scraper 45 and the locking bolt 20 can be constructed to have a tight tolerance between them. For example, the debris scraper 45 can be positioned around the locking bolt 20 and can be separated from the locking bolt 20 by approximately 2 to 5 thousandths of an inch.

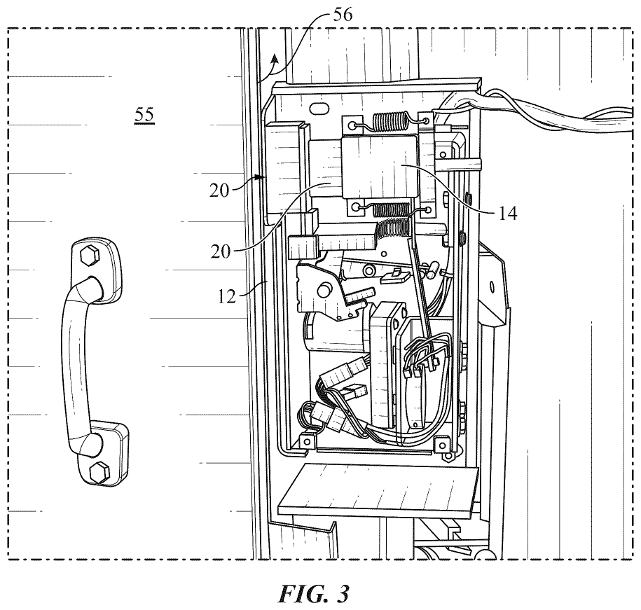

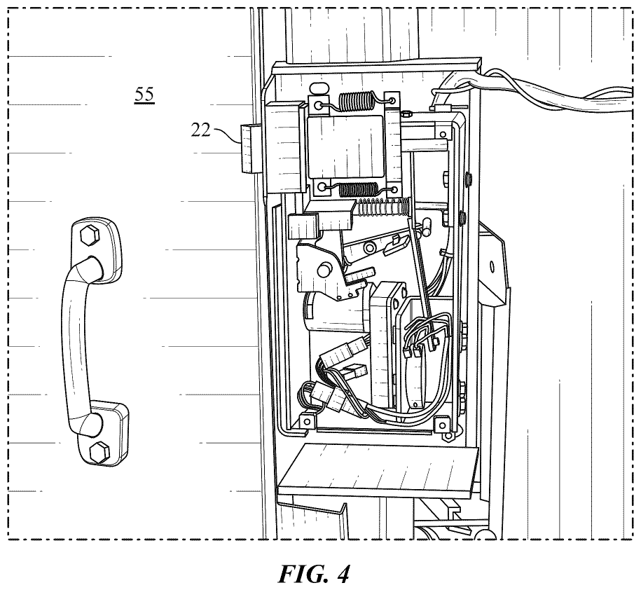

Referring to FIG. 3, in some embodiments, the end portion 22 of the locking bolt 20 can be tapered. The tapered end portion 22 of the locking bolt 20 can be constructed and arranged to be actuated by a closing door 55 so that when the locking bolt 20 is actuated by the closing door 55, the door 55 pushes the locking bolt 20 toward the lock housing 12 and out of a path 56 of the closing door 55. Referring to FIG. 4, the door 55 has closed and the tapered end portion 22 has returned to the locked position, thereby preventing the door 55 from being opened.

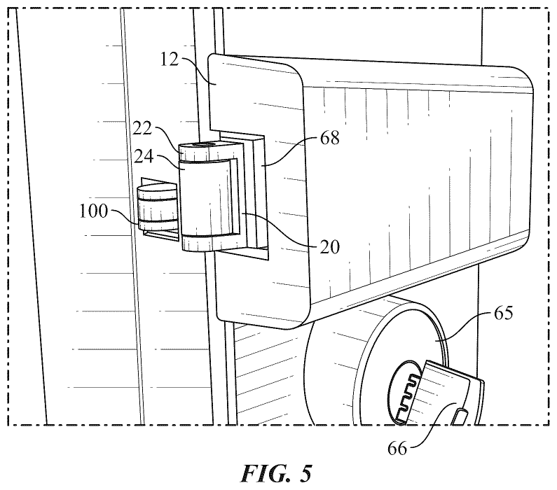

Referring to FIG. 5, in some embodiments, the lock housing 12 includes a first bolt hole 68. When the locking bolt 20 is moved to the locked position, the locking bolt 20 extends through the first bolt hole 68. In some embodiments, the end portion 22 of the locking bolt 20 can include a roller 24 that is constructed and arranged to roll on a door (e.g., 55 in FIG. 4).

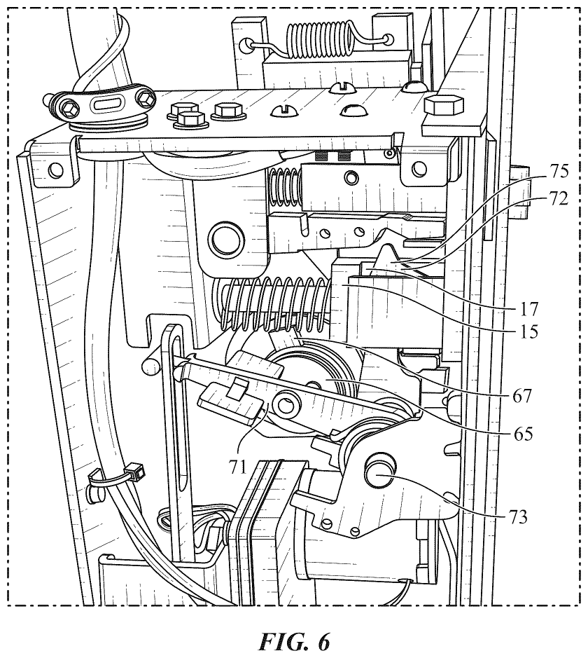

A lock cylinder 65 can be constructed and arranged to receive at least one key 66 to be actuated. Referring to FIG. 6, the lock cylinder 65 includes an actuator arm 67. The actuator arm 67 can be constructed and arranged to be in mechanical communication with the carriage (e.g., 14 in FIG. 1) so that when the lock cylinder 65 is actuated, the actuator arm 67 is actuated to cause the carriage 14 to be actuated and move to the second position 37.

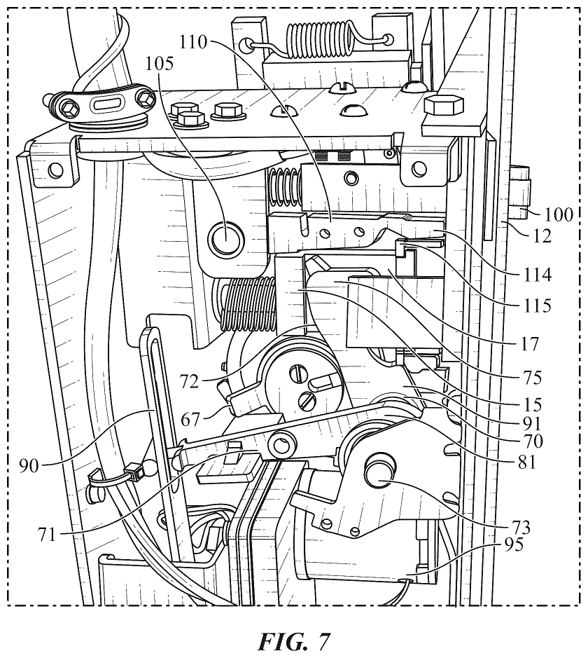

Referring to FIG. 7, a first linkage 70 can include a first arm 71 and a second arm 72. A pivot 73 can be connected to the lock housing 12. A first end 81 of the first arm 71 can be in rotational communication with a first end 91 of the second arm 72. The first end 81 of the first arm 71 and the first end 91 of the second arm 72 are rotatably connected to the pivot 73. A bottom portion 15 of the carriage 14 can have a recess 17 that receives a portion 75 of the second arm 72. When the lock cylinder 65 is actuated, the actuator arm 67 actuates the first linkage 70 to rotate the first arm 71 and the second arm 72 about the pivot 73 so that the second arm 72 engages the carriage 14, thereby actuating the carriage 14. In some embodiments, the second arm 72 engages the bottom portion 15 of the carriage 14, thereby actuating the carriage 14. The carriage 14 can be actuated so that the locking bolt 20 is in the unlocked position.

Referring to FIG. 1 and FIG. 7, an electric motor 95 can be constructed and arranged to actuate a second linkage 90. When the second linkage 90 is actuated, the second linkage 90 actuates the first linkage 70 to rotate the first arm 71 and the second arm 72 about the pivot 73 so that the second arm 72 engages the carriage 14, thereby actuating the carriage 14. A gearbox 96 can be in rotational communication with the electric motor 95 and the second linkage 90. As the electric motor 95 rotates, the gearbox 96 can actuate the second linkage 90 to raise or lower the second linkage 90. When the second linkage 90 is raised or lowered, the second linkage 90 can actuate the first linkage 70 to rotate the first arm 71 and the second arm 72 about the pivot 73 so that the second arm 72 engages the carriage 14, thereby actuating the carriage 14.

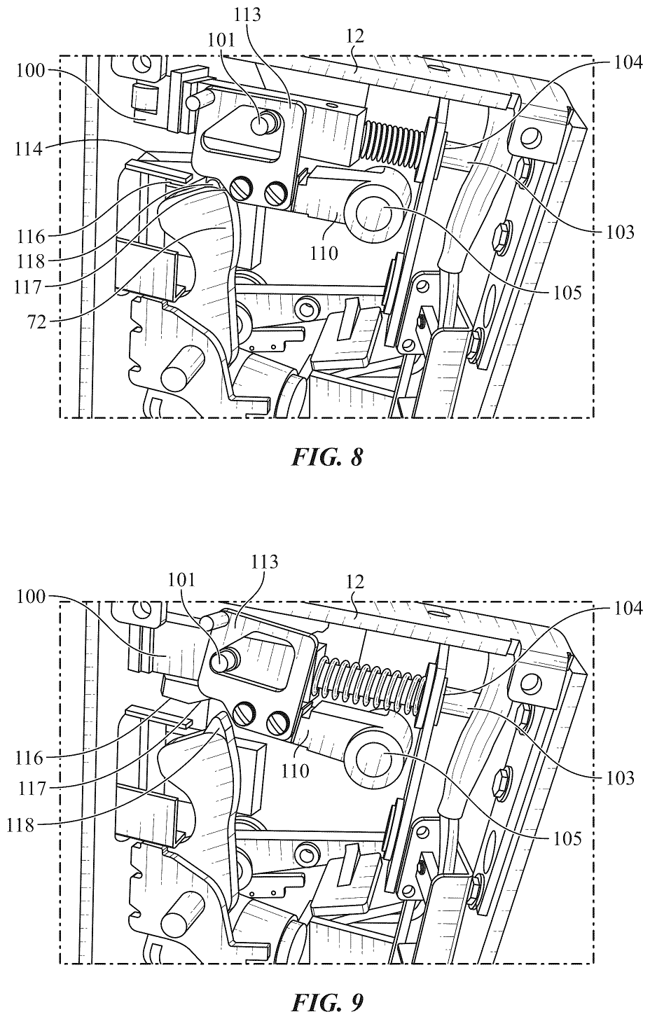

Referring to FIG. 7 and FIG. 8, in some embodiments, a push bolt 100 can be constructed and arranged to be actuated by a closing door (e.g., 55 in FIG. 4). The push bolt 100 can have a side protrusion 101. A third guided member 103 can be attached to the push bolt 100. A push bolt guide 104 can be attached to the lock housing 12. The push bolt guide 104 can be constructed and arranged to guide the third guided member 103 attached to the push bolt 100.

A first pivot 105 can be connected to the lock housing 12. A blocking arm 110 can be rotatably connected to the first pivot 105. A third linkage 113 can be attached to the blocking arm 110. When the push bolt 100 is actuated by a closing door (e.g., 55 in FIG. 4), the protrusion 101 of the push bolt 100 at least partially disengages from the third linkage 113, allowing an end 114 of the blocking arm 110 to rotate about the first pivot 105 and drop to a blocking position. When the end 114 of the blocking arm 110 is in the blocking position, the end 114 of the blocking arm 110 engages with a portion (e.g., 115 in FIG. 7) of the carriage 14 to prevent the carriage 14 from being actuated to move from the first position (e.g., 35 in FIG. 1) to the second position (e.g., 37 in FIG. 2).

Referring to FIG. 9, when the push bolt 100 is not actuated by the closing door (e.g., 55 in FIG. 4), the protrusion 101 of the push bolt 100 can engage with the third linkage 113 to lift and rotate the end 114 of the blocking arm 110 about the first pivot 105 to an unblocking position. When the end 114 of the blocking arm 110 is in the unblocking position, the end 114 of the blocking arm 110 is arranged to not engage with a portion (e.g., 115 in FIG. 7) of the carriage 14 to allow the carriage 14 to be actuated to move from the first position (e.g., 35 in FIG. 1) to the second position (e.g., 37 in FIG. 2).

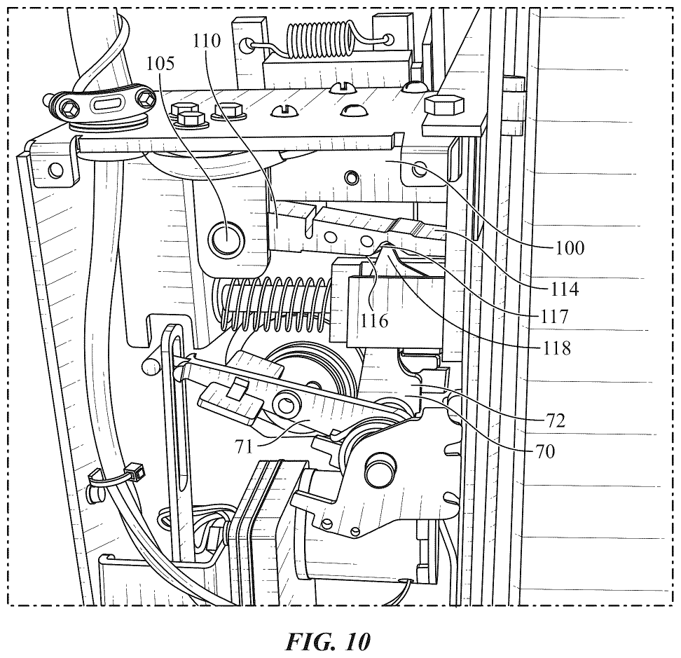

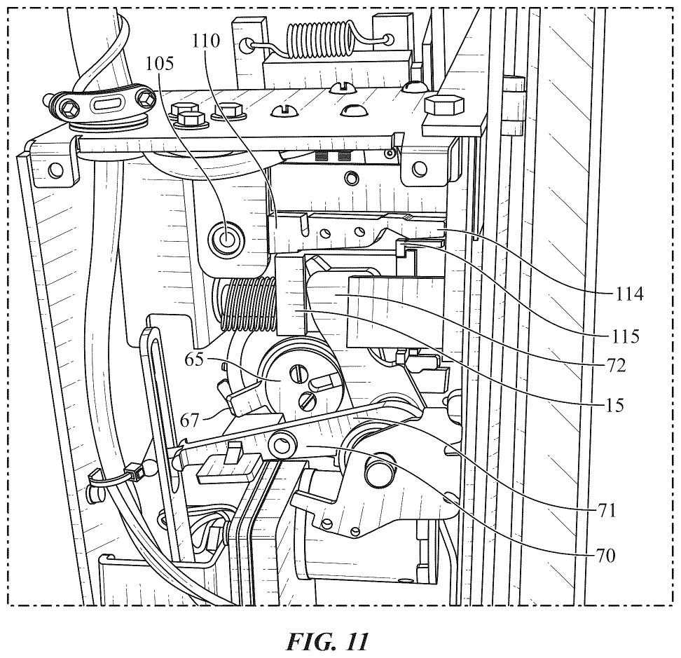

Referring to FIGS. 8 and 10, a bottom portion 116 of the blocking arm 110 has a recess 117 that receives a portion 118 of the second arm 72. Referring to FIG. 11, when the linkage 70 is actuated by the actuator arm 67 of the lock cylinder 65, the second arm 72 engages with the blocking arm 110 to lift and rotate the end 114 of the blocking arm 110 about the first pivot 105 to the unblocking position, thereby allowing the locking bolt (e.g., 20 in FIG. 1) to be actuated to move from the first position 35 to the second position 37.

The following description of variants is only illustrative of components, elements, acts, products, and methods considered to be within the scope of the invention and are not in any way intended to limit such scope by what is specifically disclosed or not expressly set forth. The components, elements, acts, products, and methods as described herein may be combined and rearranged other than as expressly described herein and are still considered to be within the scope of the invention.

According to variation 1, a locking device can include a lock housing; a first carriage attached to a first guided member and a second guided member; a locking bolt having a first portion that is slidably retained within the first carriage; a first extension spring connecting an upper portion of the first carriage to an upper portion of the locking bolt; a second extension spring connecting a lower portion of the first carriage to a lower portion of the locking bolt; a first carriage guide attached to the lock housing and positioned inside the lock housing, the first carriage guide constructed and arranged to guide the first guided member attached to the first carriage; a second carriage guide attached to the lock housing and positioned inside the lock housing, the second carriage guide constructed and arranged to guide the second guided member attached to the first carriage; wherein: the carriage is constructed and arranged to be actuated to move from at least a first position to a second position within the lock housing, the carriage being further constructed and arranged to be actuated to move from at least the second position to the first position within the lock housing; when the carriage is actuated to move to the first position, the locking bolt is moved to a locked position; when the carriage is actuated to move to the second position, the locking bolt is moved to an unlocked position.

According to variation 2, a locking device can include a lock housing; a first carriage attached to a first guided member; a locking bolt having a first portion that is slidably retained within the first carriage; a first extension spring connecting an upper portion of the first carriage to an upper portion of the locking bolt; a second extension spring connecting a lower portion of the first carriage to a lower portion of the locking bolt; a first carriage guide attached to the lock housing and positioned inside the lock housing, the first carriage guide constructed and arranged to guide the first guided member attached to the first carriage; wherein: the carriage is constructed and arranged to be actuated to move from at least a first position to a second position within the lock housing, the carriage being further constructed and arranged to be actuated to move from at least the second position to the first position within the lock housing; when the carriage is actuated to move to the first position, the locking bolt is moved to a locked position; when the carriage is actuated to move to the second position, the locking bolt is moved to an unlocked position.

According to variation 3, a locking device can include a lock housing; a first carriage attached to a first guided member; a locking bolt having a first portion that is positioned within the first carriage; a first extension spring connecting an upper portion of the first carriage to an upper portion of the locking bolt; a second extension spring connecting a lower portion of the first carriage to a lower portion of the locking bolt; a first carriage guide attached to the lock housing and positioned inside the lock housing, the first carriage guide constructed and arranged to guide the first guided member attached to the first carriage; wherein: the carriage is constructed and arranged to be actuated to move from at least a first position to a second position within the lock housing, the carriage being further constructed and arranged to be actuated to move from at least the second position to the first position within the lock housing; when the carriage is actuated to move to the first position, the locking bolt is moved to a locked position; when the carriage is actuated to move to the second position, the locking bolt is moved to an unlocked position.

Variation 4 can include the locking device of variation 1, 2, or 3, further comprising: a debris scraper mounted to the lock housing, wherein the debris scraper is constructed and arranged to scrape debris on the locking bolt as the locking bolt moves from the locked position to the unlocked position.

Variation 5 can include the locking device of variation 1, 2, or 3, wherein the locking bolt has a tapered end portion that is constructed and arranged to be actuated by a closing door so that when the locking bolt is actuated by the closing door, the door pushes the locking bolt toward the lock housing and out of a path of the closing door.

Variation 6 can include the locking device of variation 1, 2, or 3, further comprising: a lock cylinder constructed and arranged to receive at least one key to be actuated; wherein: the lock cylinder includes an actuator arm; the actuator arm is constructed and arranged to be in mechanical communication with the carriage so that when the lock cylinder is actuated, the actuator arm is actuated to cause the carriage to be actuated and move to the second position.

Variation 7 can include the locking device of variation 6, further comprising: a linkage that includes a first arm and a second arm; and a pivot that is connected to the lock housing; wherein: a first end of the first arm is in rotational communication with a first end of the second arm; the first end of the first arm and the first end of the second arm are rotatably connected to the pivot; a bottom portion of the carriage has a recess that receives a portion of the second arm; when the lock cylinder is actuated, the actuator arm actuates the linkage to rotate the first arm and the second arm about the pivot so that the second arm engages the carriage, thereby actuating the carriage.

Variation 8 can include the locking device of variation 1, 2, or 3, further comprising: a first linkage that includes a first arm and a second arm; a pivot that is connected to the lock housing; a second linkage; and an electric motor constructed and arranged to actuate the second linkage; wherein: a first end of the first arm is in rotational communication with a first end of the second arm; the first end of the first arm and the first end of the second arm are rotatably connected to the pivot; a bottom portion of the carriage has a recess that receives a portion of the second arm; when the second linkage is actuated, the second linkage actuates the first linkage to rotate the first arm and the second arm about the pivot so that the second arm engages the carriage, thereby actuating the carriage.

Variation 9 can include the locking device of variation 1, 2, or 3, further comprising: a compression spring positioned around the second guided member; wherein: the second carriage guide has an end stop surface; the compression spring is positioned between the carriage and the end stop surface; the compression spring is constructed and arranged to compress when the carriage is moved to the second position; and the compression spring is constructed and arranged to decompress to return the carriage to the first position so that the locking bolt is returned to the locked position.

Variation 10 can include the locking device of variation 1, 2, or 3, wherein: the lock housing includes a first bolt hole; when the locking bolt is moved to the locked position, the locking bolt extends through the first bolt hole.

Variation 11 can include the locking device of variation 1, 2, or 3, further comprising: a push bolt that is constructed and arranged to be actuated by a closing door, the push bolt have a side protrusion; a third guided member attached to the push bolt; a push bolt guide attached to the lock housing, the push bolt guide constructed and arranged to guide the third guided member attached to the push bolt; a first pivot that is connected to the lock housing; a blocking arm rotatably connected to the first pivot; a first linkage attached to the blocking arm; wherein: when the push bolt is not actuated by the closing door, the protrusion of the push bolt engages with the first linkage to lift and rotate an end of the blocking arm about the first pivot to an unblocking position; when the push bolt is actuated by the closing door, the protrusion of the push bolt at least partially disengages with the linkage, allowing the end of the blocking arm to rotate about the first pivot and drop to a blocking position; when the end of the blocking arm is in the blocking position, the end of the blocking arm engages with a portion of the carriage to prevent the carriage from being actuated to move from the first position to the second position.

Variation 12 can include the locking device of variation 11, further comprising: a second linkage that includes a first arm and a second arm; a second pivot that is connected to the lock housing; wherein: a first end of the first arm is in rotational communication with a first end of the second arm; the first end of the first arm and the first end of the second arm are rotatably connected to the pivot; a bottom portion of the blocking arm has a recess that receives a portion of the second arm; when the second linkage is actuated, the second arm engages with the blocking arm to lift and rotate the end of the blocking arm about the first pivot to the unblocking position, thereby allowing the locking bolt to be actuated to move from the first position to the second position.

Many different embodiments have been disclosed herein, in connection with the above description and the drawings. It will be understood that it would be unduly repetitious and obfuscating to describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for anyone of the elements in the claims below or that a single element can be substituted for two or more elements in a claim. Although elements can be described above as acting in certain combinations, and even initially claimed as such, it is to be expressly understood that one or more elements from a claimed combination can, in some cases, be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible considering the above teachings without departing from the following claims.

What is claimed is:

1. A locking device, comprising:
a lock housing;
a first carriage attached to a first guided member and a second guided member;
a locking bolt having a first portion that is slidably retained within the first carriage;
a first extension spring connecting an upper portion of the first carriage to an upper portion of the locking bolt;
a second extension spring connecting a lower portion of the first carriage to a lower portion of the locking bolt;
a first carriage guide attached to the lock housing and positioned inside the lock housing, the first carriage guide constructed and arranged to guide the first guided member attached to the first carriage;
a second carriage guide attached to the lock housing and positioned inside the lock housing, the second carriage guide constructed and arranged to guide the second guided member attached to the first carriage; wherein:
the carriage is constructed and arranged to be actuated to move from at least a first position to a second position within the lock housing, the carriage being further constructed and arranged to be actuated to move from at least the second position to the first position within the lock housing;
when the carriage is actuated to move to the first position, the locking bolt is moved to a locked position;
when the carriage is actuated to move to the second position, the locking bolt is moved to an unlocked position.

2. The locking device of claim 1, further comprising:
a debris scraper mounted to the lock housing, wherein the debris scraper is constructed and arranged to scrape debris on the locking bolt as the locking bolt moves from the locked position to the unlocked position.

3. The locking device of claim 1, wherein the locking bolt has a tapered end portion that is constructed and arranged to be actuated by a closing door so that when the locking bolt is actuated by the closing door, the door pushes the locking bolt toward the lock housing and out of a path of the closing door.

4. The locking device of claim 1, further comprising:
a lock cylinder constructed and arranged to receive at least one key to be actuated; wherein:
the lock cylinder includes an actuator arm;
the actuator arm is constructed and arranged to be in mechanical communication with the carriage so that when the lock cylinder is actuated, the actuator arm is actuated to cause the carriage to be actuated and move to the second position.

5. The locking device of claim 4, further comprising:
a linkage that includes a first arm and a second arm; and
a pivot that is connected to the lock housing; wherein:
a first end of the first arm is in rotational communication with a first end of the second arm;
the first end of the first arm and the first end of the second arm are rotatably connected to the pivot;
a bottom portion of the carriage has a recess that receives a portion of the second arm;
when the lock cylinder is actuated, the actuator arm actuates the linkage to rotate the first arm and the second arm about the pivot so that the second arm engages the carriage, thereby actuating the carriage.

6. The locking device of claim 1, further comprising:
a first linkage that includes a first arm and a second arm;
a pivot that is connected to the lock housing;
a second linkage; and
an electric motor constructed and arranged to actuate the second linkage; wherein:
a first end of the first arm is in rotational communication with a first end of the second arm;
the first end of the first arm and the first end of the second arm are rotatably connected to the pivot;
a bottom portion of the carriage has a recess that receives a portion of the second arm;
when the second linkage is actuated, the second linkage actuates the first linkage to rotate the first arm and the second arm about the pivot so that the second arm engages the carriage, thereby actuating the carriage.

7. The locking device of claim 1, further comprising:
a compression spring positioned around the second guided member; wherein:
the second carriage guide has an end stop surface;
the compression spring is positioned between the carriage and the end stop surface;
the compression spring is constructed and arranged to compress when the carriage is moved to the second position; and
the compression spring is constructed and arranged to decompress to return the carriage to the first position so that the locking bolt is returned to the locked position.

8. The locking device of claim 1, wherein:
the lock housing includes a first bolt hole;
when the locking bolt is moved to the locked position, the locking bolt extends through the first bolt hole.

9. The locking device of claim 1, further comprising:
a push bolt that is constructed and arranged to be actuated by a closing door, the push bolt have a side protrusion;
a third guided member attached to the push bolt;
a push bolt guide attached to the lock housing, the push bolt guide constructed and arranged to guide the third guided member attached to the push bolt;
a first pivot that is connected to the lock housing;
a blocking arm rotatably connected to the first pivot;
a first linkage attached to the blocking arm;
wherein:
when the push bolt is not actuated by the closing door, the protrusion of the push bolt engages with the first linkage to lift and rotate an end of the blocking arm about the first pivot to an unblocking position;
when the push bolt is actuated by the closing door, the protrusion of the push bolt at least partially disengages with the linkage, allowing the end of the blocking arm to rotate about the first pivot and drop to a blocking position;
when the end of the blocking arm is in the blocking position, the end of the blocking arm engages with a portion of the carriage to prevent the carriage from being actuated to move from the first position to the second position.

10. The locking device of claim 9, further comprising:
a second linkage that includes a first arm and a second arm;
a second pivot that is connected to the lock housing; wherein:
a first end of the first arm is in rotational communication with a first end of the second arm;
the first end of the first arm and the first end of the second arm are rotatably connected to the pivot;
a bottom portion of the blocking arm has a recess that receives a portion of the second arm;
when the second linkage is actuated, the second arm engages with the blocking arm to lift and rotate the end of the blocking arm about the first pivot to the unblocking position, thereby allowing the locking bolt to be actuated to move from the first position to the second position.

11. A locking device, comprising:
a lock housing;
a first carriage attached to a first guided member;
a locking bolt having a first portion that is slidably retained within the first carriage;
a first extension spring connecting an upper portion of the first carriage to an upper portion of the locking bolt;
a second extension spring connecting a lower portion of the first carriage to a lower portion of the locking bolt;
a first carriage guide attached to the lock housing and positioned inside the lock housing, the first carriage guide constructed and arranged to guide the first guided member attached to the first carriage; wherein:
the carriage is constructed and arranged to be actuated to move from at least a first position to a second position within the lock housing, the carriage being further constructed and arranged to be actuated to move from at least the second position to the first position within the lock housing;
when the carriage is actuated to move to the first position, the locking bolt is moved to a locked position;
when the carriage is actuated to move to the second position, the locking bolt is moved to an unlocked position.

12. The locking device of claim 11, further comprising:
a debris scraper mounted to the lock housing, wherein the debris scraper is constructed and arranged to scrape debris on the locking bolt as the locking bolt moves from the locked position to the unlocked position.

13. The locking device of claim 1, further comprising:
a lock cylinder constructed and arranged to receive at least one key to be actuated; wherein:
the lock cylinder includes an actuator arm;
the actuator arm is constructed and arranged to be in mechanical communication with the carriage so that when the lock cylinder is actuated, the actuator arm is actuated to cause the carriage to be actuated and move to the second position.

14. The locking device of claim 13, further comprising:
a linkage that includes a first arm and a second arm; and
a pivot that is connected to the lock housing; wherein:
a first end of the first arm is in rotational communication with a first end of the second arm;
the first end of the first arm and the first end of the second arm are rotatably connected to the pivot;
a bottom portion of the carriage has a recess that receives a portion of the second arm;
when the lock cylinder is actuated, the actuator arm actuates the linkage to rotate the first arm and the second arm about the pivot so that the second arm engages the carriage, thereby actuating the carriage.

15. The locking device of claim 11, further comprising:
a push bolt that is constructed and arranged to be actuated by a closing door, the push bolt have a side protrusion;
a third guided member attached to the push bolt;
a push bolt guide attached to the lock housing, the push bolt guide constructed and arranged to guide the third guided member attached to the push bolt;
a first pivot that is connected to the lock housing;
a blocking arm rotatably connected to the first pivot;
a first linkage attached to the blocking arm;
wherein:
when the push bolt is not actuated by the closing door, the protrusion of the push bolt engages with the first linkage to lift and rotate an end of the blocking arm about the first pivot to an unblocking position;
when the push bolt is actuated by the closing door, the protrusion of the push bolt at least partially disengages with the linkage, allowing the end of the blocking arm to rotate about the first pivot and drop to a blocking position;
when the end of the blocking arm is in the blocking position, the end of the blocking arm engages with a portion of the carriage to prevent the carriage from being actuated to move from the first position to the second position.

16. A locking device, comprising:
a lock housing;
a first carriage attached to a first guided member;
a locking bolt having a first portion that is positioned within the first carriage;
a first extension spring connecting an upper portion of the first carriage to an upper portion of the locking bolt;
a second extension spring connecting a lower portion of the first carriage to a lower portion of the locking bolt;
a first carriage guide attached to the lock housing and positioned inside the lock housing, the first carriage guide constructed and arranged to guide the first guided member attached to the first carriage; wherein:
the carriage is constructed and arranged to be actuated to move from at least a first position to a second position within the lock housing, the carriage being further constructed and arranged to be actuated to move from at least the second position to the first position within the lock housing;
when the carriage is actuated to move to the first position, the locking bolt is moved to a locked position;
when the carriage is actuated to move to the second position, the locking bolt is moved to an unlocked position.

17. The locking device of claim 16, further comprising:
a debris scraper mounted to the lock housing, wherein the debris scraper is constructed and arranged to scrape debris on the locking bolt as the locking bolt moves from the locked position to the unlocked position.

18. The locking device of claim 17, further comprising:
a lock cylinder constructed and arranged to receive at least one key to be actuated; wherein:
the lock cylinder includes an actuator arm;
the actuator arm is constructed and arranged to be in mechanical communication with the carriage so that when the lock cylinder is actuated, the actuator arm is actuated to cause the carriage to be actuated and move to the second position.

19. The locking device of claim 18, further comprising:
a linkage that includes a first arm and a second arm; and
a pivot that is connected to the lock housing; wherein:
a first end of the first arm is in rotational communication with a first end of the second arm;
the first end of the first arm and the first end of the second arm are rotatably connected to the pivot;
a bottom portion of the carriage has a recess that receives a portion of the second arm;
when the lock cylinder is actuated, the actuator arm actuates the linkage to rotate the first arm and the second arm about the pivot so that the second arm engages the carriage, thereby actuating the carriage.

20. The locking device of claim 17, further comprising:
a push bolt that is constructed and arranged to be actuated by a closing door, the push bolt have a side protrusion;
a third guided member attached to the push bolt;
a push bolt guide attached to the lock housing, the push bolt guide constructed and arranged to guide the third guided member attached to the push bolt;
a first pivot that is connected to the lock housing;
a blocking arm rotatably connected to the first pivot;
a first linkage attached to the blocking arm;
wherein:
when the push bolt is not actuated by the closing door, the protrusion of the push bolt engages with the first linkage to lift and rotate an end of the blocking arm about the first pivot to an unblocking position;
when the push bolt is actuated by the closing door, the protrusion of the push bolt at least partially disengages with the linkage, allowing the end of the blocking arm to rotate about the first pivot and drop to a blocking position;
when the end of the blocking arm is in the blocking position, the end of the blocking arm engages with a portion of the carriage to prevent the carriage from being actuated to move from the first position to the second position.
